(19) United States
(12) Patent Application Publication
(10) Pub. No.: US 2025/0180795 A1
(43) Pub. Date: Jun. 5, 2025

(54) REFLECTIVE BACK LIGHT UNIT OF LIQUID CRYSTAL DISPLAY

(71) Applicant: Yuwen ZHAN, Qujing (CN)

(72) Inventor: Yuwen ZHAN, Qujing (CN)

(21) Appl. No.: 19/053,158

(22) Filed: Feb. 13, 2025

Related U.S. Application Data
(63) Continuation of application No. PCT/CN2023/112790, filed on Aug. 13, 2023.

(30) Foreign Application Priority Data
Aug. 14, 2022 (CN) 202222128052.X

(51) Int. Cl. F21V 8/00

(52) U.S. Cl. CPC G02B 6/0031

(57) ABSTRACT

A reflective back light unit of liquid crystal display is provided, includes a light guide plate, a light bar, a reflective sheet attached to the back of the light guide plate and reflective sheets on three sides, a power supply interface of the light bar, and a light reflector. The light reflector is provided with an elliptic surface as the reflective surface. The light reflector covers the light emitting surface of the light bar and the light inlet surface of the light guide plate, the light emitted by the light bar is reflected by the light reflector and enters the light inlet surface of the light guide plate, and then evenly exits from the exit surface of the light guide plate through the light guide plate. The reflective back light unit is mainly used as a back light unit of eye protection liquid crystal display and natural light liquid crystal displays.

This application is a continuation of International Application No. PCT/CN2023/112790 with a filling date of Aug. 13, 2023, designating the United States, now pending, and further claims to the benefit of priority from Chinese Application No. 202222128052.X with a filing date of Aug. 14, 2022. The content of the aforementioned applications, including any intervening amendments thereto, are incorporated herein by reference.

### TECHNICAL FIELD

The present disclosure relates to the technical field of liquid crystal display, in particular to a reflective back light unit of liquid crystal display.

### BACKGROUND

Ellipses have the optical property that light rays originating from one focal point of an ellipse, after elliptical reflecting, the reflected light pass through the other focal point of the ellipse.

A natural light liquid crystal display is a type of liquid crystal display that can be used by illuminating the back of the liquid crystal display screen with natural light.

Among the patents published on the website of the China National Intellectual Property Administration of the People's Republic of China, the patent with publication number CN114675367A and application date of Apr. 5, 2022, discloses an eye protection lamp and a liquid crystal display, liquid crystal screen terminal, and billboard composed of it. The eye protection lamp can be used as a back light unit of liquid crystal display. By setting a light reflector, the light emitted by the light bar can be reflected to the light inlet surface of the light guide plate, and then the light can be evenly emitted from the exit surface of the light guide plate through the light guide plate.

### Technical Problem

Among the patents published on the website of the China National Intellectual Property Administration of the People's Republic of China, the patent with the announcement number of CN 114675367 A and the application date of 2022Apr. 5 discloses an eye protection lamp and a liquid crystal display, a liquid crystal screen terminal, and a billboard composed of it. The eye protection lamp can be used as the back light unit of the liquid crystal display. By setting a light reflector, the light emitted by the light bar can be reflected to the light inlet surface of the light guide plate, and then the light can be evenly emitted from the exit surface of the light guide plate through the light guide plate. However, according to the specification, there is no design for a light reflector with an elliptical curved cross-section, which cannot allow most of the light emitted by the light bar to enter the light guide plate after one reflection, resulting in low energy efficiency; the light guide plate inside the liquid crystal display panel of portable terminals is generally very thin, and some light rays still cannot successfully enter the light inlet surface of the light guide plate after multiple reflections, resulting in a darker backlight.

### SUMMARY

The objective of the present disclosure is to provide a reflective back light unit of liquid crystal display to solve the problems raised in the background. To achieve the above objective, the present disclosure provides the following technical solution:

A reflective back light unit of liquid crystal display includes a light guide plate, a light bar, a reflective sheet attached to the back of the light guide plate and reflective sheets on the three sides of the light guide plate and a power supply interface of the light bar. The reflective back light unit of liquid crystal display further includes a light reflector, the light reflector is a casing with a groove, and an elliptic surface with a cross-section of an elliptical arc is provided inside the groove as a reflective surface, wherein the elliptical arc is a semi-elliptical arc or a part of the semi-elliptical arc cut by the ellipse through its long axis, and the elliptic surface is a surface obtained by stretching an elliptic arc in the direction normal to the plane in which it is located. An inner surface of the light reflector, i.e. the groove, is coated with a reflective coating being capable of absorbing harmful blue light or a reflective film being capable of absorbing harmful blue light, a long axis of an ellipse where the elliptical arc is located is perpendicular to an exit surface of the light guide plate, the light bar is arranged on an outside the reflective sheet on a back of the light guide plate, an orientation of the light bar is such that the light emitted by the light bar deviates from the light inlet surface of the light guide plate, the groove of the light reflector covers a light emitting surface of the light bar and a light inlet surface of the light guide plate, the light emitted by the light bar is reflected by the light reflector and enters the light inlet surface of the light guide plate, and then evenly exits from the exit surface of the light guide plate through the light guide plate. Further, one focal point of the ellipse where the elliptical arc of any cross-section of the elliptic surface in the light reflector is located is located on the light bar, and an other focal point is located on the light inlet surface of the light guide plate.

Optionally, a back light unit casing can be arranged to cover the back and three sides of the light guide plate. At the same time, the inner surface of the back light unit casing has a reflective coating, so there is no need to stick reflective paper on the side of the light guide plate as a reflective sheet. The bottom surface of the casing can be used as a reflective sheet on the back of the light guide plate. The reflective coating material is a high reflectivity material that absorbs harmful blue light and other high-frequency light, which can be tested one by one through a spectrometer, such as using white paint.

Further, a prism film is further attached to the exit surface of the light guide plate to enhance the brightness of the front side of the back light unit.

Further, a diffusion film is further provided outside the prism film to make the light emitted from the front of the back light unit more uniform.

Further, the light bar is provided with LED beads with warm color temperature and white color temperature, and the LED beads with the two color temperatures are respectively provided with independent power supply and brightness adjustment circuits, achieving electrodeless color temperature adjustment between the warm color temperature and the white color temperature.

Optionally, the reflective back light unit of liquid crystal display is further provided with a backlight power switch and a hinge, so as to be hinged to the back of the natural light liquid crystal display for use as the back light unit of the natural light liquid crystal display. The function of the backlight power switch is: when the light is sufficient, the back light unit is turned on by rotation, and the power supply of the light bar is turned off by the backlight power supply switch, so that the liquid crystal display screen is directly illuminated by natural light for working use, and at the same time, the back light unit has a certain ability of reflecting natural light to the back of the liquid crystal display screen, which can further increase the brightness of the liquid crystal display screen; when the light is insufficient, the back light unit is rotated and closed, the power supply of the light bar is turned on through the backlight power supply switch, and the light emitted by the light bar is used to illuminate the liquid crystal display screen for working use.

Further, the light bar uses violet-excited LED beads with no peak blue light as the light source.

Further, when the light bar takes the back of the light guide plate as the horizontal plane to be moved and placed behind to the back of the light inlet surface of the light guide plate, a metal shielding sheet is provided between the light guide plate and the light bar to shield the light emitted from a side of the light bar close to the light guide plate from directly entering the light guide plate.

### Advantageous Effect

According to the reflective back light unit of liquid crystal display, by providing the light reflector with an elliptical cross-section, the light utilization efficiency of the reflective back light unit is improved, and the brightness of the reflective back light unit is improved; in the process of light reflection, the reflective coating and the light reflector absorb most harmful blue light and other high-frequency light, thereby protecting eyes, and the reflected light is more in line with the usage habits of human eyes.

### BRIEF DESCRIPTION OF THE DRAWINGS

FIG. 1 is a schematic structure diagram of a reflective back light unit of liquid crystal display viewed from the back.

FIG. 2 is a schematic structure diagram of a reflective back light unit of liquid crystal display viewed from the front.

FIG. 3 is an enlarged partial view of a light reflector of a reflective back light unit of liquid crystal display.

FIG. 4 is an enlarged partial view of a junction box of a backlight circuit of a reflective back light unit of liquid crystal display.

FIG. 5 is a schematic cross-sectional view of a reflective back light unit of liquid crystal display.

FIG. 6 is a schematic diagram of light propagation of a backlight of a reflective back light unit of liquid crystal displays.

FIG. 7 is a schematic structure diagram of a reflective back light unit of liquid crystal display installed with a hinge when the reflective back light unit used as a back light unit of a natural light liquid crystal display.

FIG. 8 is a schematic structure diagram of a natural light liquid crystal display when a reflective back light unit of liquid crystal display is installed on the back of a natural light liquid crystal display.

FIG. 9 is a schematic structure diagram that a reflective back light unit of liquid crystal display is installed on the back of a natural light liquid crystal display and the back light unit is turned on to illuminate the liquid crystal display completely using natural light from the environment when viewed from the front.

FIG. 10 is a schematic diagram of the structure that the reflective back light unit of a liquid crystal display is installed on the back of a natural light liquid crystal display and the back light unit is turned on to illuminate the liquid crystal display completely using the natural light from the environment when viewed from the back.

Reference numbers in the drawings: 1—the reflective sheet on the back of light guide plate; 2—the reflective sheet on the side of light guide plate; 3—light reflector casing; 4—backlight circuit junction box; 5—light guide plate; 6—backlight power switch; 7—light bar fixing plate; 8—heat dissipation hole of light bar fixing plate; 9—aluminum substrate of light bar; 10—power supply interface of the light bar; 11—purple light excitation LED bead; 12—light inlet surface of light guide plate; 13—light reflector; 14—light; 15—hinge; 16—fixing frame of back light unit; 17—VESA standard display bracket; 18—quick release adaptor plate of back light unit; 19—natural light liquid crystal display casing; 20—backlight power supply line; 21—natural light liquid crystal display frame; 22—liquid crystal display screen; 23—speaker; 24—the diffusion film on the back of the liquid crystal display screen.

### DETAILED DESCRIPTION OF THE EMBODIMENTS

The following provides a further detailed illustration of the technical solution of the present disclosure in conjunction with specific embodiments.

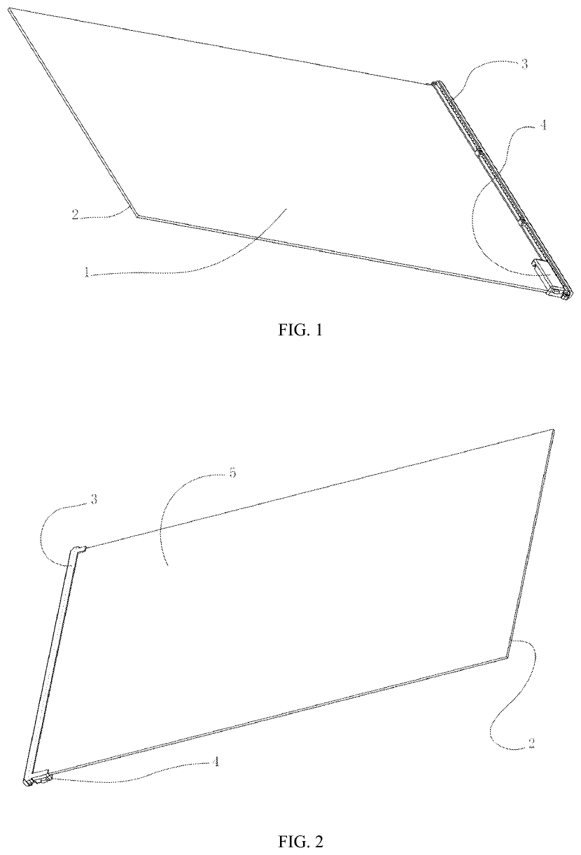

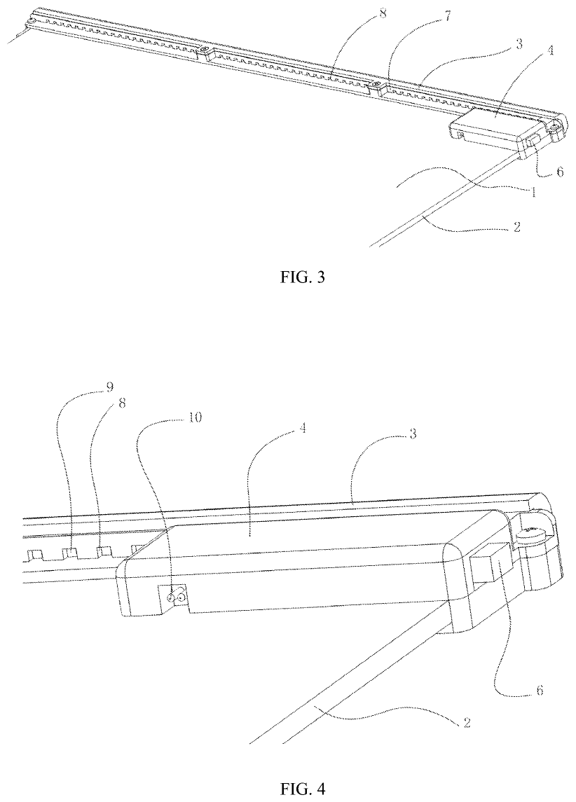

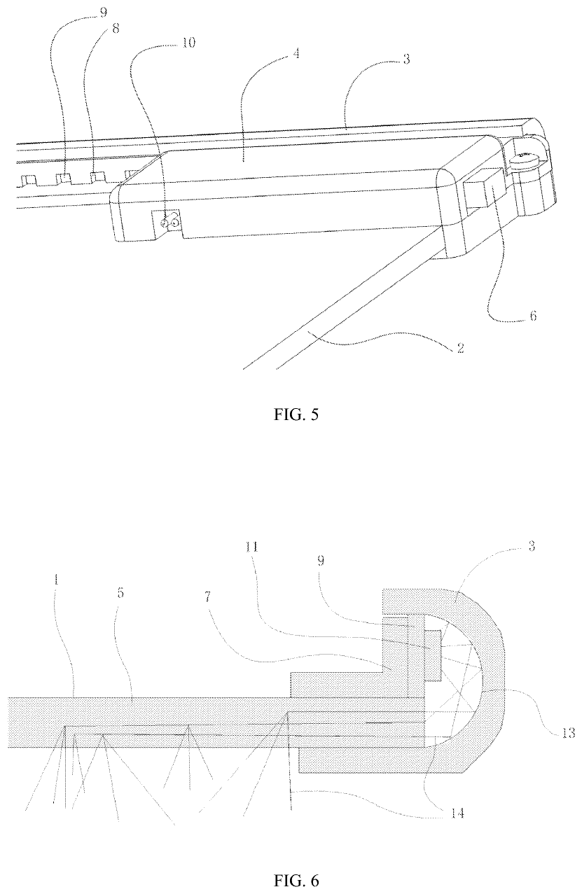

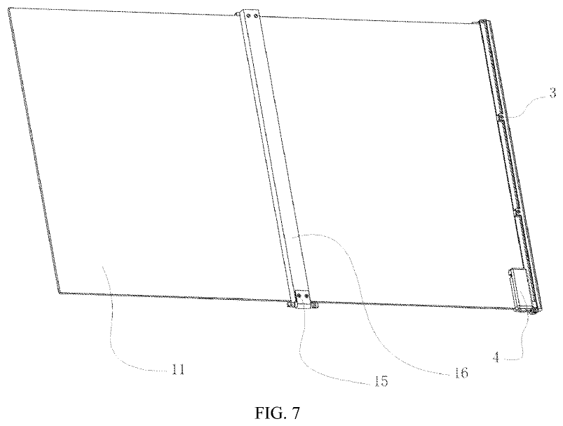

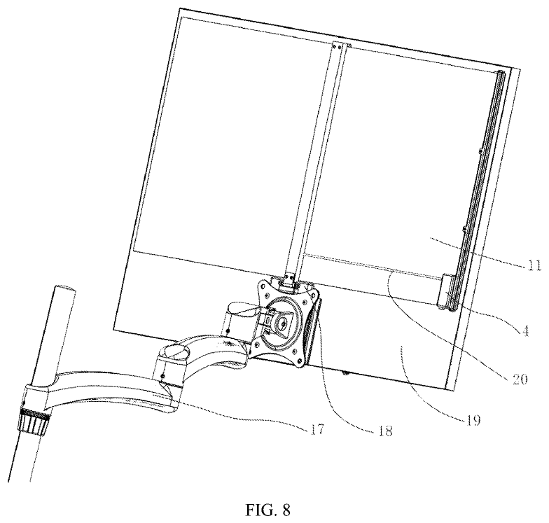

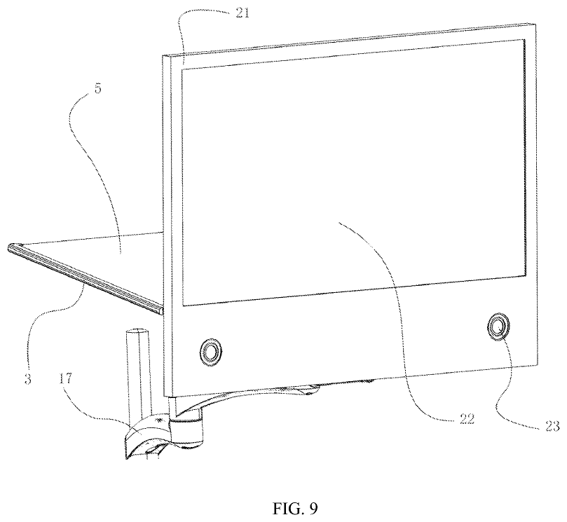

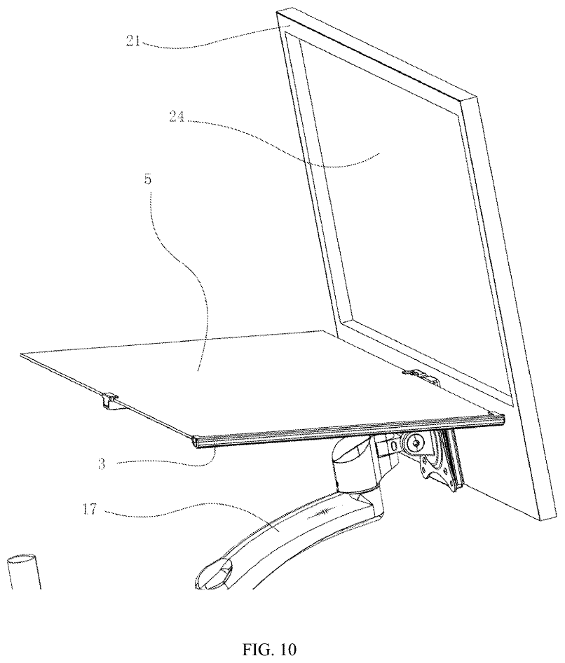

Embodiment 1: as shown in FIGS. 1 to 10, a reflective back light unit of liquid crystal display includes a light guide plate 5, a light bar, a reflective sheet attached to the back of the light guide plate, the reflective sheets on the three sides of the light guide plate 2 and a power supply interface of the light bar 10. The reflective back light unit of liquid crystal display further includes a light reflector 13. The light reflector is a casing with a groove, and an elliptic surface with the cross-section of an elliptical arc is provided inside the groove as a reflective surface. The inner surface of the light reflector, i.e. the groove, is coated with a reflective coating that can absorb harmful blue light or a reflective film that can absorb harmful blue light. The long axis of the ellipse where the elliptical arc is located is perpendicular to the exit surface of the light guide plate. The light bar is arranged on the outside the reflective sheet on the back of the light guide plate through a light bar fixing plate, and the orientation of the light bar is such that the light emitted by the light bar deviates from the light inlet surface of the light guide plate, the groove of the light reflector covers the light emitting surface of the light bar and the light inlet surface of the light guide plate. The light emitted by the light bar is reflected by the light reflector and enters the light inlet surface of the light guide plate, and then evenly exits from the exit surface of the light guide plate through the light guide plate. One focal point of the ellipse where the elliptical arc of any cross-section of the elliptic surface inside the light reflector is located is located on the aluminum substrate surface of the light bar, and the other focal point is located on the light inlet surface of the light guide plate.

The light bar uses violet-excited LED beads 11 with no peak blue light as the light source.

The light reflector and the light bar fixing plate are fixed by screws, and the middle light guide plate and the reflective sheet on the back of the light guide plate are clamped. The light reflector and the light bar fixing plate are fixed on one side of the light guide plate's light inlet surface by the frictional force generated by clamping the light guide plate.

The material of the reflective coating is high reflectivity white paint that absorbs harmful blue light and other high-frequency light.

The reflective back light unit of liquid crystal display is further provided with a backlight power switch 6 and a hinge 15, so as to be hinged to the back of the natural light liquid crystal display for use as the back light unit of the natural light liquid crystal display. At the same time, a backlight power supply line is provided to connect the back light unit with the backlight power supply interface of the liquid crystal display driver board. When the light is sufficient, the back light unit is turned on by rotation, and the power supply of the light bar is turned off by the backlight power supply switch, so that the liquid crystal display screen is directly illuminated by natural light for working use, and at the same time, the back light unit has a certain ability of reflecting natural light to the back of the liquid crystal display screen, which can further increase the brightness of the liquid crystal display screen; when the light is insufficient, the back light unit is rotated and closed, the power supply of the light bar is turned on through the backlight power supply switch, and the light emitted by the light bar is used to illuminate the liquid crystal display screen 22 for working use.

### Industrial Applicability

By setting an elliptic surface with an elliptical cross-section as the reflective surface of the light reflector, the light utilization efficiency of the reflective back light unit is improved, and the brightness of the reflective back light unit is increased. During the light reflection process, the reflective coating and light reflector absorb most of the harmful blue light and other high-frequency light, and the reflected light is used for illumination that is more in line with human eye habits, thus protecting the eyes, and viewing the liquid crystal display composed of the reflected back light unit has the effect of eye comfort without dryness and stinging.

The substrate of the light bar is provided with a through hole as the optical fiber lighting interface, the optical fiber lighting interface can be connected to a variety of optical fiber lighting system as a light source to illuminate the liquid crystal display screen. The optical fiber can be bent, enabling the liquid crystal display to be placed at any angle and illuminated by natural light for use. The backlight energy consumption accounts for more than half of the total energy consumption of the display, and using sunlight as a light source to illuminate the liquid crystal display screen can save most of the electricity consumption. The human eye is more attuned to the natural light illumination obtained by reflecting sunlight, so that the use of solar light guiding light illumination system as a light source through the reflection of natural light to illuminate the liquid crystal display screen can improve the display effect.

All parts of the reflective back light unit are convenient to process and assemble, the structure is firm and durable, maintenance is not required during use, the use and operation are simple, and there is no safety problem during use.

In the description of the present disclosure, it should be noted that unless otherwise specified and limited, the term “connection” should be broadly understood, specifically, it can be an electrical connection, a mechanical connection, or a signal connection. In summary, although the present disclosure has been disclosed in conjunction with the preferred embodiments above, it is not intended to limit the present disclosure. Those skilled in the art to which the present disclosure belongs can make various changes and modifications without departing from the spirit and scope of the present disclosure. Therefore, the scope of the present disclosure should be as defined in the appended claims.

What is claimed is:

1. A reflective back light unit of liquid crystal display, comprising a light guide plate, a light bar, a reflective sheet arranged on a back of the light guide plate, reflective sheets on three sides of the light guide plate and a power supply interface of the light bar, wherein the reflective back light unit of liquid crystal display further comprises a light reflector, the light reflector is a casing with a groove, and an elliptic surface with a cross-section of an elliptical arc is provided inside the groove as a reflective surface, an inner surface of the light reflector, i.e. the groove, is coated with a reflective coating being capable of absorbing harmful blue light or a reflective film being capable of absorbing harmful blue light, a long axis of an ellipse where the elliptical arc is located is perpendicular to an exit surface of the light guide plate, the light bar is arranged on an outside the reflective sheet on the back of the light guide plate, an orientation of the light bar is such that the light emitted by the light bar deviates from a light inlet surface of the light guide plate, a groove of the light reflector covers a light emitting surface of the light bar and the light inlet surface of the light guide plate, the light emitted by the light bar is reflected by the light reflector and enters the light inlet surface of the light guide plate, and then evenly exits from the exit surface of the light guide plate through the light guide plate.

2. The reflective back light unit of liquid crystal display according to claim 1, wherein one focal point of the ellipse where the elliptical arc of any cross-section of the elliptic surface inside the light reflector is located is located on the light bar, and an other focal point is located on the light inlet surface of the light guide plate.

3. The reflective back light unit of liquid crystal display according to claim 1, wherein a prism film is further attached to the exit surface of the light guide plate.

4. The reflective back light unit of liquid crystal display according to claim 3, wherein a diffusion film is further provided outside the prism film.

5. The reflective back light unit of liquid crystal display according to claim 1, wherein the light bar is provided with LED beads with warm color temperature and white color temperature, and the LED beads with the warm color temperature and the white color temperature are respectively provided with independent power supply and brightness adjustment circuits.

6. The reflective back light unit of liquid crystal display according to claim 1, wherein the reflective back light unit of liquid crystal display is further provided with a backlight switch and a hinge, so as to be hinged to a back of a natural light liquid crystal display for use as a back light unit for the natural light liquid crystal display.

7. The reflective back light unit of liquid crystal display according to claim 1, wherein the light bar uses violet-excited LED beads as the light source.

8. The reflective back light unit of liquid crystal display according to claim 1, wherein a metal shielding sheet is provided between the light guide plate and the light bar to shield the light emitted from a side of the light bar close to the light guide plate directly entering the light guide plate.
